(19) United States
(12) Patent Application Publication
(10) Pub. No.: US 2026/0214718 A1
(43) Pub. Date: Jul. 23, 2026

(54) EARLY USER EQUIPMENT IDENTIFICATION AND POWER REPORT

(71) Applicant: Telefonaktiebolaget LM Ericsson (PUBL), Stockholm (SE)

(72) Inventors: Olof Liberg, ENSKEDE (SE); Johan Rune, LIDINGÖ (SE); Robert Karlsson, SUNDBYBERG (SE); Stefan Eriksson Löwenmark, FÄRENTUNA (SE); Andreas Höglund, SOLNA (SE)

(21) Appl. No.: 19/140,235

(22) PCT Filed: Dec. 22, 2023
(86) PCT No.: PCT/EP2023/087563

§ 371 Date: Jun. 17, 2025

Related U.S. Application Data
(60) Provisional application No. 63/476,682, filed on Dec. 22, 2022.

(51) Int. Cl. H04W 74/0833; H04W 52/36; H04W 72/21

(52) U.S. Cl. CPC H04W 74/0833; H04W 52/365; H04W 72/21

(57) ABSTRACT

The disclosure refers to a method performed by a wireless device, the method comprising obtaining an indication that the wireless device should use one or more bits of a random access procedure message 3 to indicate a capability of the wireless device for performing repetition when transmitting a random access procedure message 4 physical uplink control channel; setting one or more bits of the random access procedure message 3 to indicate the capability of the wireless device for performing repetition when transmitting the random access procedure message 4 physical uplink control channel; and transmitting the random access procedure message 3 to a network node.

### TECHNICAL FIELD

Embodiments of the present disclosure are directed to wireless communications and, more particularly, to early user equipment (UE) identification and power report.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Third Generation Partnership Project (3GPP) specifies the evolved packet system (EPS). EPS is based on the long-term evolution (LTE) radio network and the evolved packet core (EPC). EPS was originally intended to provide voice and mobile broadband (MBB) services but has continuously evolved to broaden its functionality. 3GPP also specifies narrowband Internet of things (NB-IoT) and LTE for machines (LTE-M) as part of the LTE specifications and provide connectivity to massive machine type communications (mMTC) services.

3GPP also specifies the fifth generation (5G) system (5GS). This is a new generation radio access technology intended to serve use cases such as enhanced mobile broadband (eMBB), ultra-reliable and low latency communication (URLLC) and mMTC. 5G includes the new radio (NR) access stratum interface and the 5G core network (5GC). The NR physical and higher layers reuse parts of the LTE specification, and to that add needed components when motivated by the new use cases. One such component is a sophisticated framework for beam forming and beam management to extend the support of the 3GPP technologies to a frequency range going beyond 6 GHz.

In 3GPP release 15, 3GPP started the work to prepare NR for operation in a non-terrestrial network (NTN) (e.g., satellite communications). The work was performed within the study item “NR to support Non-Terrestrial Networks” and resulted in TR 38.811. In 3GPP release 16, the work to prepare NR for operation in an NTN network continued with the study item “Solutions for NR to support Non-Terrestrial Network.” In parallel the interest to adapt NB-IoT and LTE-M for operation in NTN is growing. As a consequence, 3GPP release 17 contains both a work item on NR NTN and a study item on NB-IoT and LTE-M support for NTN.

In 3GPP NTN includes both satellite communication and communications using high-altitude platforms (HAPS). Particular examples herein may focus on satellite communication, but the provided description may also be applied to a HAPS network.

A satellite radio access network usually includes the following components: a satellite that refers to a space-borne platform; an earth-based gateway that connects the satellite to a base station or a core network, depending on the choice of architecture; a feeder link that refers to the link between a gateway and a satellite; and an access link that refers to the link between a satellite and a user equipment (UE).

Depending on the orbit altitude, a satellite may be categorized as low earth orbit (LEO), medium earth orbit (MEO), or geostationary earth orbit (GEO) satellite. LEO includes typical heights ranging from 250-1,500 km, with orbital periods ranging from 90-120 minutes. MEO includes typical heights ranging from 5,000-25,000 km, with orbital periods ranging from 3-15 hours. GEO includes height at about 35,786 km, with an orbital period of 24 hours.

A communication satellite typically generates several beams over a given area. The footprint of a beam is usually in an elliptic shape, which has been traditionally considered as a cell. The footprint of a beam is also often referred to as a spotbeam. The footprint of a beam may move over the earth surface with the satellite movement or may be earth fixed with some beam pointing mechanism used by the satellite to compensate for its motion. The size of a spotbeam depends on the system design, which may range from tens of kilometers to a few thousands of kilometers.

Two basic architectures have been considered. One is the transparent payload (also referred to as bent pipe architecture). In this architecture, the gNB is located on the ground and the satellite forwards signals/data between the gNB and the UE. Another is the regenerative payload. In this architecture the gNB is located in the satellite. In the work item for NR NTN in 3GPP release 17, only the transparent architecture is considered.

FIG. 1 shows an example architecture of a satellite network with bent pipe transponders. The depicted elevation angle of the service link is important because it impacts the distance between the satellite and the device and the velocity of the satellite relative to the device. The gNB may be integrated in the gateway or connected to the gateway via a terrestrial connection (wire, optic fiber, wireless link).

Before accessing an NR NTN, a UE is required to acquire the system information blocks (SIBs) broadcasted by a satellite access node (SAN), i.e. a gNB serving an NTN. SIB19 is specific for NTN cells and contains information element (IE) NTN-Config-r17 that provides NTN specific information needed by a UE to access an NTN cell. One example is the ephemeris data, which provides the satellite orbit. A UE may use this information to, for example, determine the pointing direction of a directional antenna (or an antenna beam) towards the satellite. A UE knowing its own position, e.g. using global navigation satellite system (GNSS) support, may also use the ephemeris data to calculate correct timing advance (TA) and Doppler shift used when establishing a link to the satellite. The presence of NTN-Config-r17 in SIB19 informs a UE that it is camping on an NTN cell.

When a UE accesses a NR cell from Radio Resource Control (RRC) idle or RRC inactive states, the UE needs to provide its identity (ID) to the network. When accessing from RRC idle, the UE will signal its ID, known as 5G S temporary mobile subscriber identity (5G-S-TMSI), across Message 3 (Msg3) and Message 5 (Msg5) during connection setup.

When a UE accesses from RRC inactive mode, the UE uses a shorter UE ID referred to as the inactive radio network temporary identifier (I-RNTI) that the UE sends as part of Msg3. After the UE identity is known to the gNB, the gNB can fetch the UE capabilities from the UE context stored in the Access and Mobility Management Function (AMF).

FIG. 2 is a flow diagram illustrating the NR random access procedure from RRC idle mode. Not illustrated is that a UE sends a HARQ Ack/Nack over the physical uplink control channel (PUCCH) in response to Msg4.

Msg3 carries, e.g., the RRCSetupRequest message from a UE accessing from RRC idle, and RRCResumeRequest for a UE accessing from RRC inactive state. The below text provides the RRCSetupRequest definition according to TS 38.331 v 17.2.0. One bit is spare, which means that it has been reserved for use in later releases. The EstablishmentCause field also contains spare code points.

| | |
|---|---|
| RRCSetupRequest ::= | SEQUENCE { |
| rrcSetupRequest | RRCSetupRequest-IEs |
| } | |
| RRCSetupRequest-IEs ::= | SEQUENCE { |
| ue-Identity | InitialUE-Identity, |
| establishmentCause | EstablishmentCause, |
| spare | BIT STRING (SIZE (1)) |
| } | |
| InitialUE-Identity ::= | CHOICE { |
| ng-5G-S-TMSI-Part1 | BIT STRING (SIZE (39)), |
| randomValue | BIT STRING (SIZE (39)) |
| } | |
| EstablishmentCause ::= | ENUMERATED { |
| | emergency, highPriorityAccess, mt-Access, mo- |
| Signalling, | |
| | mo-Data, mo-VoiceCall, mo-VideoCall, mo-SMS, mps- |
| PriorityAccess, mcs-PriorityAccess, | |
| | spare6, spare5, spare4, spare3, spare2, spare1} |

In Msg3, the UE also adds a medium access control (MAC) header to the RRC message according to 38.321 v 17.2.0 when forming the MAC protocol data unit (PDU) that is sent to the UE's physical layer. Because Msg3 contains the logical channel uplink (UL) common control channel (CCCH), the MAC header contains two reserved bits (“R”) and the 6-bit logical channel ID (LCID), as shown in FIG. 3.

FIG. 3 is a reproduction of TS 38.321 v17.2.0 FIG. 6.1.2-3 showing the R/LCID/(eLCID) MAC subheader.

The LCID definition according to TS 38.321 v 17.2.0 is presented below and does, as shown, contain seven reserved codepoints (37-42, 47).

TABLE 1
TS 38.321 v17.2.0 table 6.2.1-2 values of LCID for UL-SCH

| Codepoint/ | |
|---|---|
| Index | LCID values |
| 0 | CCCH of size 64 bits (referred to as “CCCH1” |
| | in TS 38.331), except for a RedCap UE |
| 1-32 | Identity of the logical channel of DCCH and DTCH |
| 33 | Extended logical channel ID field (two-octet eLCID field) |
| 34 | Extended logical channel ID field (one-octet eLCID field) |
| 35 | CCCH of size 48 bits (referred to as “CCCH” |
| | in TS 38.331) for a RedCap UE |
| 36 | CCCH of size 64 bits (referred to as “CCCH1” |
| | in TS 38.331) for a RedCap UE |
| 37-42 | Reserved |
| 43 | Truncated Enhanced BFR (one octet Cᵢ) |
| 44 | Timing Advance Report |
| 45 | Truncated Sidelink BSR |
| 46 | Sidelink BSR |
| 47 | Reserved |
| 48 | LBT failure (four octets) |
| 49 | LBT failure (one octet) |
| 50 | BFR (one octet Cᵢ) |
| 51 | Truncated BFR (one octet Cᵢ) |
| 52 | CCCH of size 48 bits (referred to as “CCCH” |
| | in TS 38.331), except for a RedCap UE |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

Msg4 PUCCH refers to the usage of the PUCCH for the UE's transmission of HARQ feedback in response to Msg4 reception. Thus, Msg4 PUCCH transmission refers to such HARQ feedback transmissions and Msg4 PUCCH repetition refers to repetitions of such HARQ feedback transmissions for the purpose of coverage enhancement

To assist a gNB for performing uplink link adaptation, a NR UE supports power headroom (PHR) reporting during RRC connected mode. The PHR indicates how high of a transmit power a UE uses or would like to use according to its uplink power control algorithm relative its maximum allowed output power. The PHR will therefore, e.g., indicate to the network that: a UE does not use its full available transmit power; a UE uses X dB (e.g., 3 dB) less than its full available transmit power; a UE uses its full power; or if a UE uses its full power and would like to use more.

The NW may use this information when performing uplink adaptation and select uplink transmission bandwidth, if a UE should repeat an uplink transmission or not and select the best modulation and coding scheme for the uplink transmission.

There currently exist certain challenges. For example, 3GPP has agreed to improve uplink coverage for an NTN UE during initial access. To this end, a UE may repeat the Msg4 PUCCH transmission to improve the robustness of the transmission. There are, however, at least three problems that need to be addressed to facilitate repetition of Msg4 PUCCH transmission.

One problem is that a UE does not send a PHR to the network before Msg4, which makes it challenging for the network to determine the UE uplink radio conditions to determine if the UE should use Msg4 PUCCH repetitions or not. Another problem is that the gNB is not aware if the UE supports repeated Msg4 PUCCH transmission. Without this knowledge, the network will first find out the UE capabilities for a UE that is accessing from RRC idle after Msg5 transmission. This is too late for a capability that relates to Msg4 PUCCH transmissions. Another problem is that the 3GPP specifications need to be updated to support indication of if, and how many, repetitions a NTN UE should use for Msg4 PUCCH transmission. Msg1 PHR and capability indication may be an option for addressing these problems, but this comes at a high cost in terms of reduced random-access capacity and is therefore not explored in further detail herein.

### SUMMARY

As described above, certain challenges currently exist with early user equipment (UE) identification and power report. Certain aspects of the present disclosure and their embodiments may provide solutions to these or other challenges. For example, particular embodiments include early UE capability signaling in Msg3 for the support of Msg4 physical uplink control channel (PUCCH) repetitions. Some embodiments include early power headroom (PHR) reporting in Msg3. In some embodiments, the number of repetitions to be used when transmitting Msg4 PUCCH is configurable. Some embodiments may control when the above signaling is applicable.

In general, particular embodiments use one or more spare bits in Msg3 for indicating that a UE supports Msg4 PUCCH repetitions and for performing PHR. The spare bits refer to reserved bit fields in the Msg3 Radio Resource Control (RRC) and medium access control (MAC) protocols that have so far not been used by Third Generation Partnership Project (3GPP).

To control the usage of these bits, some embodiments only use the spare bits when a UE is accessing a cell in an non-terrestrial network (NTN). Further, the usage may be controlled by indications in the system information, which facilitates other deployment options and features to use the same bits for other purposes.

According to some embodiments, a method performed by a wireless device comprises: obtaining an indication that the wireless device should use one or more bits of a random access procedure message 3 to indicate a capability of the wireless device for performing repetition when transmitting a random access procedure message 4 physical uplink control channel; setting one or more bits of the random access procedure message 3 to indicate the capability of the wireless device for performing repetition when transmitting the random access procedure message 4 physical uplink control channel; and transmitting the random access procedure message 3 to a network node.

In particular embodiments, obtaining the indication further comprises obtaining an indication that the wireless device should use one or more bits of the random access procedure message 3 to indicate a capability of the wireless device for reporting power headroom; and setting one or more bits of the random access procedure message 3 further comprises setting one or more bits of the random access procedure message 3 to indicate the capability of the wireless device for reporting power headroom. In particular embodiments, one or more bits of the random access procedure message 3 further indicate a power headroom measurement performed by the wireless device.

In particular embodiments, obtaining the indication comprises obtaining system information, obtaining a random access response, or a combination of both. In particular embodiments, obtaining the indication comprises obtaining an indication that the wireless device is accessing a non-terrestrial network.

In particular embodiments, obtaining the indication further comprises obtaining an indication of a number of repetitions the wireless device is to use when transmitting a random access procedure message 4 physical uplink control channel.

According to some embodiments, a wireless device comprises processing circuitry operable to perform any of the methods of the wireless device described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method performed by a network node comprises receiving a random access procedure message 3 from a wireless device. The message 3 comprises one or more bits indicating a capability of the wireless device for performing repetition when transmitting a random access procedure message 4 physical uplink control channel. The method further comprises receiving one or more repetitions of the random access procedure message 4 from the wireless device.

In particular embodiments, the message 3 further comprises an indication that the wireless device is capable of using one or more bits of the random access procedure message 3 to indicate a capability of the wireless device for reporting power headroom. In particular embodiments, the one or more bits of the random access procedure message 3 further indicate a power headroom measurement performed by the wireless device.

In particular embodiments, the method further comprises transmitting to the wireless device an indication that the wireless device should use one or more bits of a random access procedure message 3 to indicate a capability of the wireless device for performing repetition when transmitting a random access procedure message 4 physical uplink control channel. In particular embodiments, transmitting the indication comprises transmitting system information, transmitting a random access response, or a combination of both.

In particular embodiments, transmitting the indication further comprises transmitting an indication of a number of repetitions the wireless device is to use when transmitting a random access procedure message 4 physical uplink control channel.

According to some embodiments, a network node comprises processing circuitry operable to perform any of the methods of the network node described above.

Also disclosed is a computer program product comprising a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments facilitate signaling for improved Msg4 PUCCH link adaptation, that is if the UE can increase the transmission power and if the UE can use Msg4 PUCCH repetitions. After decoding Msg3, the gNB is aware of the transmit power that the UE is using, whether the UE may increase the transmit power, and whether the UE can make Msg4 PUCCH repetitions. The signaling uses reserved bits in RRC and/or MAC and can be controlled in the system information, thus enabling the usage of these reserved bits by other future functionalities when not needed for PHR/capability indications. Another advantage is that the improved Msg4 PUCCH link adaptation avoids excess uplink repetitions and thus saves radio resources and UE energy as well as decreasing interference.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 shows an example architecture of a satellite network with bent pipe transponders;

FIG. 2 is a flow diagram illustrating the NR random access procedure from RRC idle mode;

FIG. 3 is a reproduction of TS 38.321 v17.2.0 FIG. 6.1.2-3 showing the R/LCID/(eLCID) MAC subheader;

FIG. 4 is a block diagram illustrating an example wireless network;

FIG. 5 illustrates an example user equipment, according to certain embodiments;

FIG. 6 illustrates an example virtualization environment, according to certain embodiments;

FIG. 7 illustrates an example telecommunication network connected via an intermediate network to a host computer, according to certain embodiments;

FIG. 8 illustrates an example host computer communicating via a base station with a user equipment over a partially wireless connection, according to certain embodiments;

FIG. 9 is a flowchart illustrating a method implemented, according to certain embodiments;

FIG. 10 is a flowchart illustrating a method implemented in a communication system, according to certain embodiments;

FIG. 11 is a flowchart illustrating a method implemented in a communication system, according to certain embodiments;

FIG. 12 is a flowchart illustrating a method implemented in a communication system, according to certain embodiments;

FIG. 13A is a flowchart illustrating a method performed by a wireless device, according to certain embodiments;

FIG. 13B is a flowchart illustrating a method performed by a first network node, according to certain embodiments;

FIG. 13C is a flowchart illustrating a method performed by a second network node, according to certain embodiments;

FIG. 14 is a flowchart illustrating another method performed by a first network node, according to certain embodiments; and

FIG. 15 is a flowchart illustrating another method performed by a second network node, according to certain embodiments.

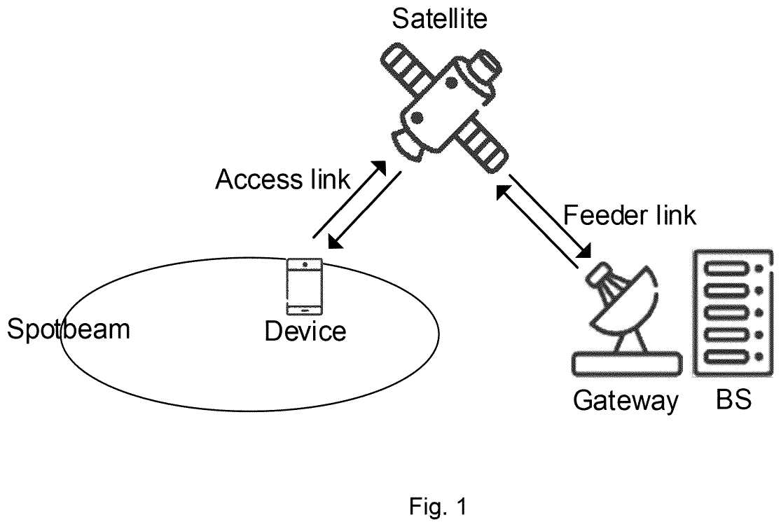

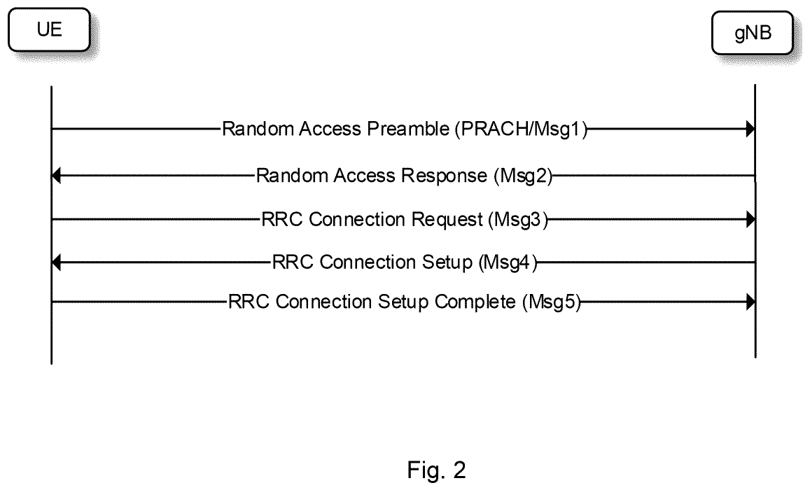

### DETAILED DESCRIPTION

As described above, certain challenges currently exist with early user equipment (UE) identification and power report. Certain aspects of the present disclosure and their embodiments may provide solutions to these or other challenges. For example, particular embodiments include early UE capability signaling in Msg3 for the support of Msg4 physical uplink control channel (PUCCH) repetitions. Some embodiments include early power headroom (PHR) reporting in Msg3.

Particular embodiments are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

The embodiments outlined below are described mainly in terms of NR based non-terrestrial networks (NTNs), but they are equally applicable in a NTN based on Long Term Evolution (LTE) technology or any other radio access technology (RAT) where measurement windows and gaps may be configured. The embodiments described herein refer to explicit and implicit network configurations applied to NTNs, however, similar configuration may also be applied in terrestrial networks.

In a first group of embodiments, a UE in an NTN may use one or more bits in Msg3 for reporting its capability to use repetitions on Msg4 PUCCH, and/or perform a PHR. The UE may use the reception of SIB19 NTN-Config information element as indication of being in an NTN cell. If only PHR is reported, the UE support/capability for Msg4 PUCCH repetition may either be implicit from the UE supporting NTN (and thus performing the access attempt in the NTN cell), or from the UE including the above Msg3 PHR reporting.

In some embodiments, whether the one or more bits in Msg3 is/are to be used for indicting Msg4 PUCCH capability indication and/or a PHR is configured in the system information (SI). For example, a flag indicating on/off of this feature may be included in the SI. As another example, a multi-bit indicator may be included in the SI, wherein its value indicates which of a number of different specified (in a standard) usages of the one or more bits in Msg3. As one option, the number of repetitions to use when Msg4 PUCCH is repeated may be configured in the SI.

In some embodiments, the configuration related to usage of the one or more Msg3 bits for the purpose of indicating Msg4 PUCCH repetition capability and/or PHR (and the abovementioned configuration of the number of Msg4 PUCCH repetitions) are included in the SI only in NTN cells, e.g. in cells where SIB19 is broadcast (including the NTN-Config-r17 IE) (or where SIB31 is broadcast in an IoT NTN). Absence of such configuration may imply that the one or more Msg3 bits are not to be used for the purpose of indicating Msg4 PUCCH repetition capability and/or PHR.

As one option, the above-mentioned configurations may be included in SIB19 (or in SIB31 for an IoT NTN). In another option, the above-mentioned configurations may be included in SIB1.

In some embodiments, configuration may be provided in the random access response (RAR) message. The examples above described how usage of the one or more Msg3 bits may be configured via the SI. An alternative way to configure the usage is to use RA Msg2, i.e., the RAR message.

In some embodiments, the reserved bit in the MAC RAR may be used, which may signal on/off of usage of the one or more Msg3 bits for indication of Msg4 PUCCH repetition capability and/or PHR (where “on” may, e.g., be indicated by setting the reserved bit to one).

In some embodiments, one or two reserved bits in a MAC subheader in the RAR (i.e., in the payload in the RAR PDU may be used. For example, one or both of the two reserved bits in the MAC subheader containing a backoff indicator may be used. If the gNB does not want to signal any backoff indication, the gNB may still use the reserved bit(s) in this way by setting the backoff indicator field to one of the reserved codepoints (which are 14 and 15 in release 17 of the 3GPP standard). Also in these embodiments, a single reserved bit may signal on/off of usage of the one or more Msg3 bits for indication of Msg4 PUCCH repetition capability and/or PHR (where “on” may, e.g., be indicated by setting the reserved bit to one).

If both of the reserved bits in the MAC subheader containing a backoff indicator are used, or if both a reserved bit in the MAC RAR and a reserved bit in the MAC subheader containing a backoff indicator are used for this dynamic configuration, then they may be combined to a two-bit configuration indication, which, similar to what is described above for configuration via the SI, may indicate which of, e.g., three or four different specified (in a standard) usages of the one or more bits in Msg3 the UE should apply. As a further option, the reserved bit in the MAC RAR and both the reserved bits in the MAC subheader containing a backoff indicator may be used for the dynamic configuration, thereby constituting a three-bit configuration, which facilitates even more configuration possibilities, e.g., indicating one out of a set of specified (in a standard) usages of the one or more bits in Msg3 the UE should apply, and/or possibly indicate the number of Msg4 PUCCH repetitions to be used.

Using the RAR to dynamically configure the usage (or non-usage) of the one or more Msg3 bits for indication of Msg4 PUCCH repetition capability and/or PHR enables the network to be more flexible and configure this on a case per case basis.

The dynamic configuration via the RAR may be used in combination with configuration in the SI. Then, the configuration in the SI may be the default configuration, which may be overridden by a configuration signaled in the RAR. For example, if the SI (explicitly or implicitly) indicates that the UE by default should not use the one or more Msg3 bits for indication of Msg4 PUCCH repetition capability and/or PHR, this may be overridden in a specific case by setting the reserved bit(s) (which are used for configuration as described above) to one.

Indication of Msg4 PUCCH capability requires only a single bit. A PHR, on the other hand, may consist of one or more bits. A single-bit PHR may indicate whether the UE used full transmission power (e.g., indicated by setting the bit to one) or less than full transmission power (e.g., indicated by setting the bit to zero) for the transmission of Msg1 and/or Msg3. As another alternative, a single-bit PHR may indicate whether the UE used a transmission power greater than X dB below full transmission power (e.g., indicated by setting the bit to one) or a transmission power that was more than X dB below full transmission power (e.g., indicated by setting the bit to zero) for the transmission of Msg1 and/or Msg3 (where X may be e.g. 3 dB).

A multi-bit PHR facilitates signaling of more than two ranges for the transmission power used for Msg1 and/or Msg3.

The Msg4 PUCCH capability and the PHR may also be combined, e.g., into a single bit indicator. Such a single bit combined indicator may, e.g., be set to one to indicate that the UE is capable of performing Msg4 PUCCH repetition and used full transmission power for the transmission of Msg1 and/or Msg3. As another alternative, setting a single bit combined indicator to one could indicate that the UE is capable of performing Msg4 PUCCH repetition and used a transmission power for the Msg1 and/or Msg3 transmission that was greater than X dB below full transmission power (e.g., thereby indicating close to full transmission power).

If multiple Msg3 bits are used, some embodiments may indicate a preferred number of Msg4 PUCCH repetitions, e.g., using two bits to point out one out of four specified or preconfigured (e.g., in the SI) Msg4 PUCCH repetition numbers.

In some embodiments, the number of Msg4 PUCCH repetitions is implied by the information provided by the UE. The number of Msg4 PUCCH repetitions to apply may be indicated in the downlink control information (DCI) providing the downlink scheduling assignment for Msg4 or may be configured in the system information.

However, in other embodiments, the number of Msg4 repetitions to apply may be implied by the information provided by the UE in the one or more Msg3 bits.

In some embodiments, the number of Msg4 PUCCH repetitions to use may be derived from the value the UE provides in the PHR (e.g., using more than one of the one or more Msg3 bits for the PHR). If more than one bit is used for the PHR, different Msg4 PUCCH configurations may correspond to the different signaled PHR values. For example, if a 2-bit PHR is used, 4 different numbers of repetition for Msg4 PUCCH corresponding to these PHR values may be indicated in the SI, or specified in the standard, and a UE reporting a certain PHR value should apply the number of Msg4 PUCCH repetitions associated with the reported PHR value (e.g., the corresponding number of repetitions indicated in the system information).

In some embodiments, the same multi-bit indication principle is used, but based on a multi-bit Msg4 PUCCH repetition capability indication instead of a multi-bit PHR.

In some embodiments, separate from a PHR and/or Msg4 PUCCH repetition capability indication, one or more of the Msg3 bits may be used to indicate the number of Msg4 PUCCH repetition. As above, as one option, the different bit combinations may be tied to (associated with) different specified or configured (e.g., in the SI) numbers of Msg4 PUCCH repetitions.

In a variation of any of the above embodiments, the number of Msg4 PUCCH repetitions indicated by the information provided by the UE in the Msg3 bits are the UE preferred number of Msg4 PUCCH repetitions. The gNB may take this indicated UE preference into account when determining the number of Msg4 PUCCH repetitions to configure the UE to apply, e.g., in the DCI providing the downlink scheduling assignment for Msg4. In some embodiments, a UE uses the spare bit in RRCSetupRequest, RRCResumeRequest, RRCResumeRequest1 and/or RRCReestablishmentRequest message to indicate to the network that the UE: is capable of performing Msg4 PUCCH repetitions; used full, or close to full, power at transmission of Msg1 and/or Msg3; or is capable of performing Msg4 PUCCH repetitions and used full, or close to full, power at transmission of Msg1 and/or Msg3.

Close to full power, as used herein, means that the UE transmitted at a power X dB below its max transmit power, and that the network configures the UE with the value X or that the value X is captured in a technical specification or configured by the network in system information.

In some embodiments, one or more new EstablishmentCause is used to indicate any of the above to the network instead of using the spare bit.

In some embodiments, the semantics of the usage of the spare bit depends on the establishmentCause (in the RRCSetupRequest message), the resumeCause (in the RRCResumeRequest message and/or the RRCResumeRequest1 message) and/or the reestablishmentCause (in the RRCReestablishmentRequest message). For example, the above described indication provided by the spare bit may be valid only if the establishmentCause has one or more certain value(s). Other establishmentCause values may imply that the spare bit carries no significance (i.e., it is still to be regarded as a spare bit) or, as another option, may imply that the spare bit is used to indicate something else.

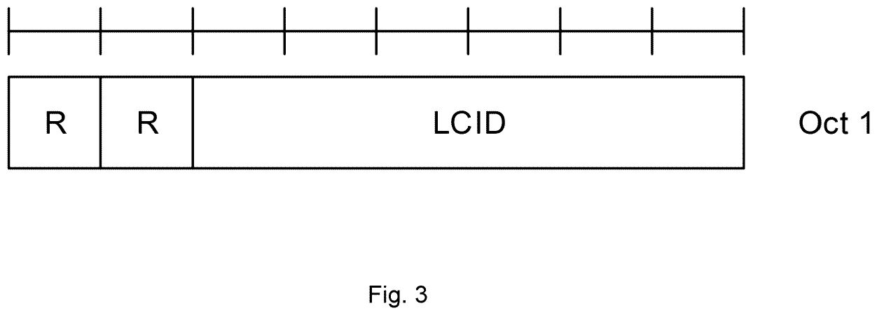

In some embodiments, a UE uses one spare bit in the MAC subheader (see R bits in FIG. 3) to indicate to the network that the UE: is capable of performing Msg4 PUCCH repetitions; used full, or close to full, power at transmission of Msg1 and/or Msg3; or is capable of performing Msg4 PUCCH repetitions and used full, or close to full, power at transmission of Msg1 and/or Msg3.

In some embodiments, a UE uses two spare bits in the MAC subheader to indicate to the network that the UE is capable of performing Msg4 PUCCH repetitions and performs a PHR, i.e., informs the network about how much power it uses relative its maximum power.

In one example, the following signaling may be specified for the four different combinations of the two spare bits:
00: Msg4 PUCCH repetitions is supported, and Msg3 PHR is not supported.
01: Msg4 PUCCH repetitions is supported, and the UE uses full power (P_{full}).
10: Msg4 PUCCH repetitions is supported, and the UE uses a transmission power, Pₜᵣₐₙₛ, such that P_{full}−3 dB≤Pₜᵣₐₙₛ<P_{full}.
11: Msg4 PUCCH repetitions is supported, and the UE uses a transmission power, Pₜᵣₐₙₛ, such that Pₜᵣₐₙₛ<P_{full}−3 dB.

In some embodiments, a UE uses one or more reserved LCID codepoints to indicate that the UE is capable of performing Msg4 PUCCH repetitions and used full, or close to full, power at transmission of Msg1 and/or Msg3 as indicated in the below table.

TABLE 2
TS 38.321 v17.2.0 table 6.2.1-2 values of LCID for UL-SCH

| Codepoint/ | |
|---|---|
| Index | LCID values |
| 0 | CCCH of size 64 bits (referred to as “CCCH1” |
| | in TS 38.331), except for a RedCap UE |
| 1-32 | Identity of the logical channel of DCCH and DTCH |
| 33 | Extended logical channel ID field (two-octet eLCID field) |
| 34 | Extended logical channel ID field (one-octet eLCID field) |
| 35 | CCCH of size 48 bits (referred to as “CCCH” |
| | in TS 38.331) for a RedCap UE |
| 36 | CCCH of size 64 bits (referred to as “CCCH1” |
| | in TS 38.331) for a RedCap UE |
| 37 | CCCH of size 48 bits (referred to as “CCCH” |
| | in TS 38.331) for a non-RedCap UE that |
| | used full power for Msg1 and/or Msg3, and |
| | supports Msg4 PUCCH repetitions |
| 38 | CCCH of size 64 bits (referred to as “CCCH1” |
| | in TS 38.331) for a non-RedCap UE that: |
| | used full power for Msg1 and/or Msg3, and |
| | supports Msg4 PUCCH repetitions |
| 39 | CCCH of size 48 bits (referred to as “CCCH” |
| | in TS 38.331) for a RedCap UE |
| | used full power for Msg1 and/or Msg3, and |
| | supports Msg4 PUCCH repetitions |
| 40 | CCCH of size 64 bits (referred to as “CCCH1” |
| | in TS 38.331) for a RedCap UE |
| | used full power for Msg1 and/or Msg3, and |
| | supports Msg4 PUCCH repetitions |
| 41-42 | Reserved |
| 43 | Truncated Enhanced BFR (one octet Cᵢ) |
| 44 | Timing Advance Report |
| 45 | Truncated Sidelink BSR |
| 46 | Sidelink BSR |
| 47 | Reserved |
| 48 | LBT failure (four octets) |
| 49 | LBT failure (one octet) |
| 50 | BFR (one octet Cᵢ) |
| 51 | Truncated BFR (one octet Cᵢ) |
| 52 | CCCH of size 48 bits (referred to as “CCCH” |
| | in TS 38.331), except for a RedCap UE |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

In the above table, the UE reporting ‘full power used for Msg1 and/or Msg3’, i.e. a one or few bit PHR, may be replaced with a UE indication to request Msg4 PUCCH repetition. The request for Msg4 PUCCH repetition may include an indication of a preferred repetition factor.

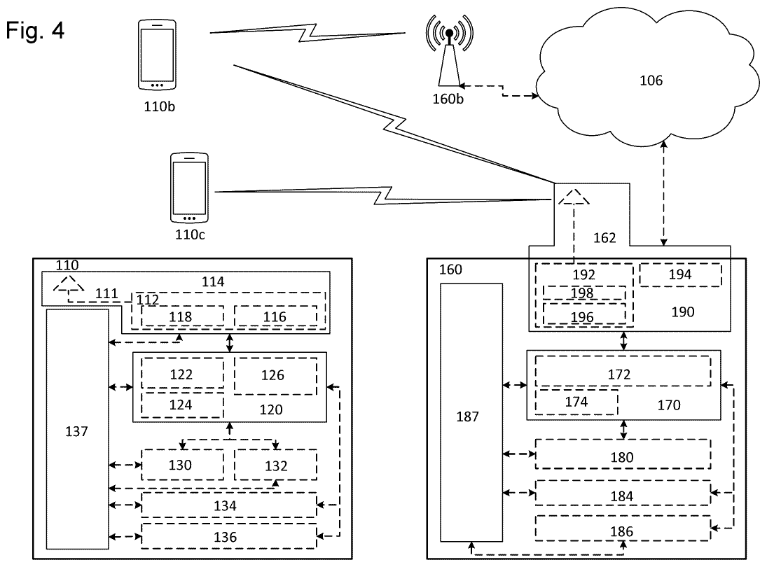

FIG. 4 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 4, network node 160 includes processing circuitry 170, device readable medium 180, interface 190, auxiliary equipment 184, power source 186, power circuitry 187, and antenna 162. Although network node 160 illustrated in the example wireless network of FIG. 4 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 4 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

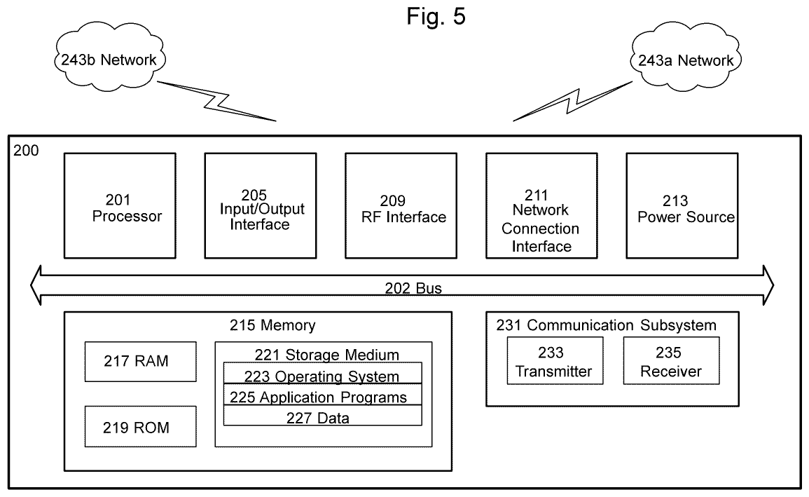

FIG. 5 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 5, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 5 is a UE, the components discussed herein are equally applicable to a WD, and vice-versa.

In FIG. 5, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 5, or only a subset of the components. The level of integration between the components may vary from one UE to another UE. Further, certain UEs may contain multiple instances of a component, such as multiple processors, memories, transceivers, transmitters, receivers, etc.

In FIG. 5, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 5, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 5, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

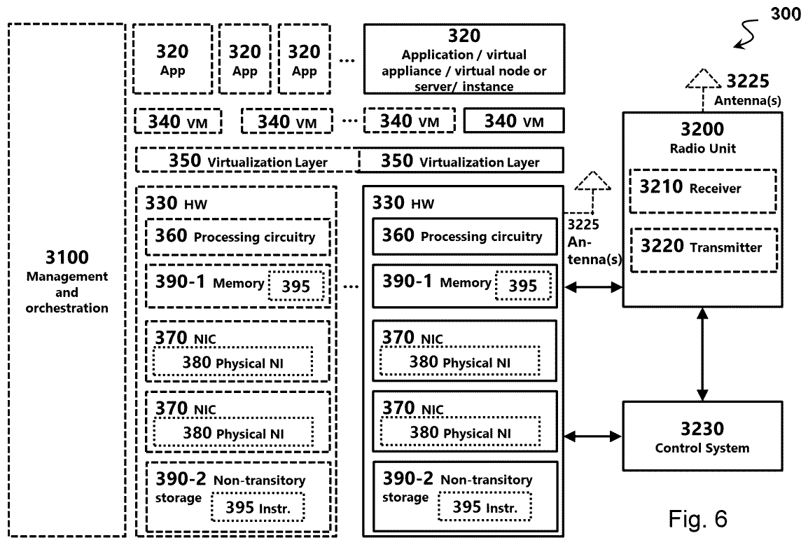

FIG. 6 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 6, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 18. In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

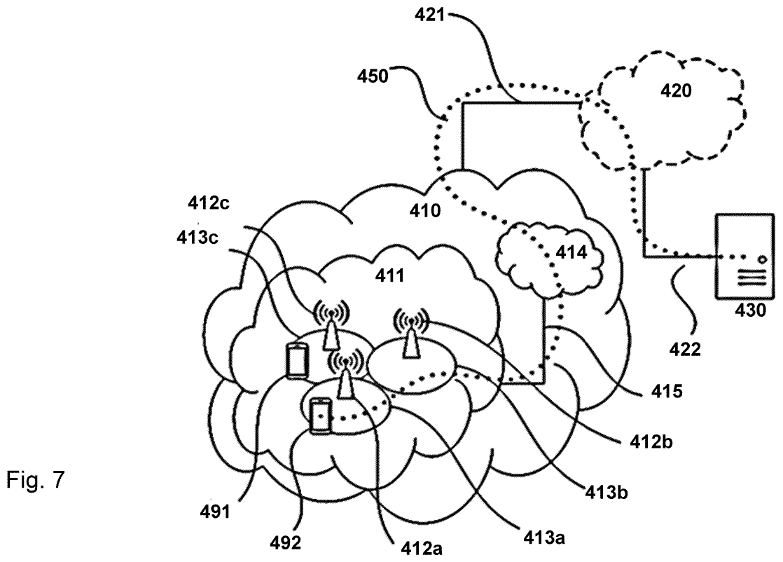

With reference to FIG. 7, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 7 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

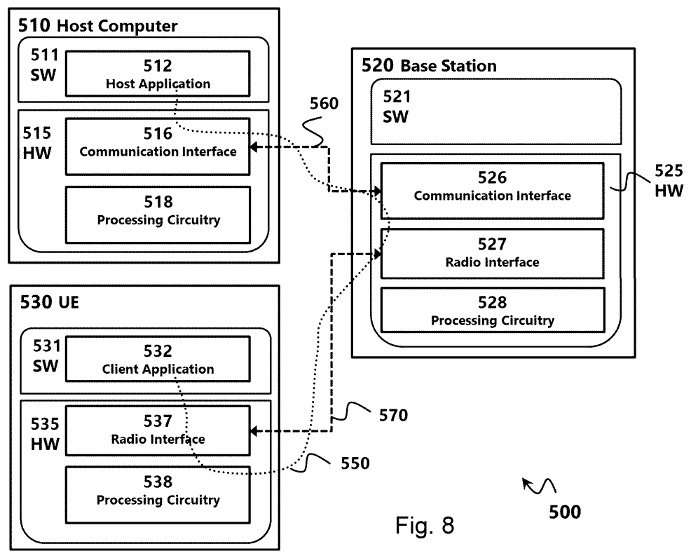

FIG. 8 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 8. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 8) served by base station 520. Communication interface 526 may be configured to facilitate connection 560 to host computer 510. Connection 560 may be direct, or it may pass through a core network (not shown in FIG. 8) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 8 may be similar or identical to host computer 430, one of base stations 412a, 412b, 412c and one of UEs 491, 492 of FIG. 4, respectively. This is to say, the inner workings of these entities may be as shown in FIG. 8 and independently, the surrounding network topology may be that of FIG. 4.

In FIG. 8, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, which may provide faster internet access for users.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

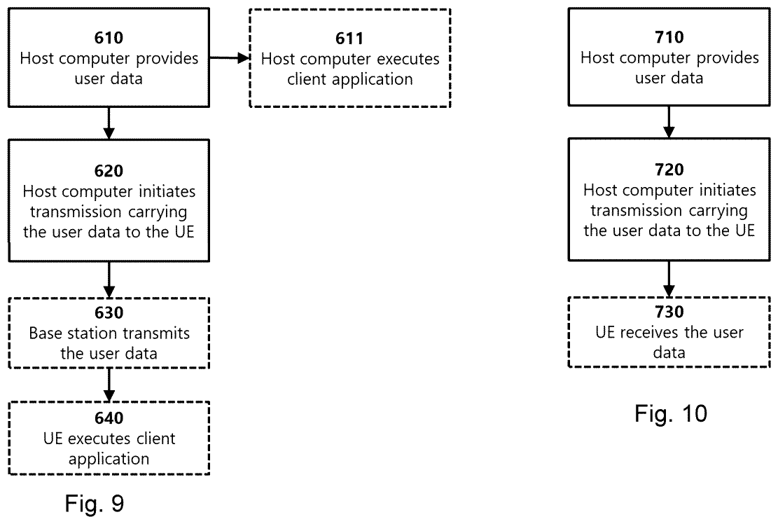

FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section.

In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

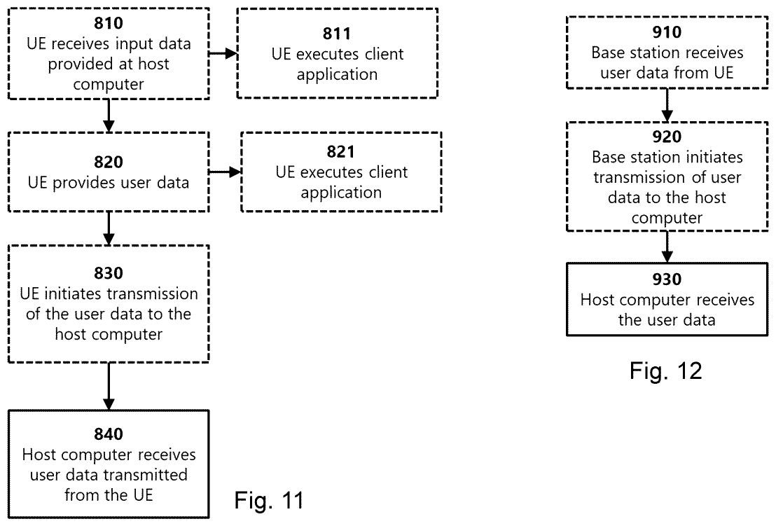

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section.

In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 12 will be included in this section.

In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

In the examples and embodiments described herein, when a message is transmitted to a wireless device or to a network node, the message may be transmitted directly or indirectly, via one or more intermediate network nodes or wireless devices. Similarly, when a message is received from a wireless device or to a network node, the message may be received directly or indirectly, via one or more intermediate network nodes or wireless devices.

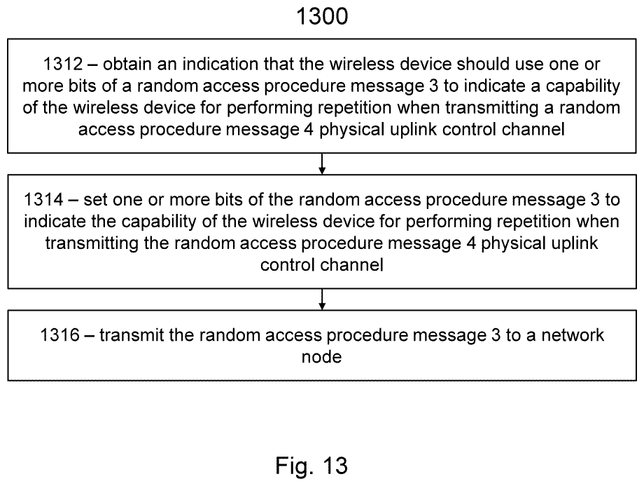

FIG. 13 is a flowchart illustrating a method 1300 performed by a wireless device according to certain embodiments. In particular embodiments, one or more steps of FIG. 13 may be performed by wireless device 110 described with respect to FIG. 4.

The method begins at step 1312, where the wireless device (e.g., wireless device 110) obtains an indication that the wireless device should use one or more bits of a random access procedure message 3 to indicate a capability of the wireless device for performing repetition when transmitting a random access procedure message 4 physical uplink control channel.

In particular embodiments, obtaining the indication comprises obtaining system information (e.g., SIB1, SIB19, SIB31, etc.), obtaining a random access response (e.g. MAC RAR and/or MAC subheader), or a combination of both. For example, a default configuration may be signaled by the system information and overriding information may be signaled when needed using the RAR.

In particular embodiments, obtaining the indication comprises obtaining an indication that the wireless device is accessing a non-terrestrial network. For example, the presence of SIB 19 or any other indicator, explicit or implicit, that the wireless device is accessing a non-terrestrial network.

In particular embodiments, obtaining the indication further comprises obtaining an indication of a number of repetitions the wireless device is to use when transmitting a random access procedure message 4 physical uplink control channel.

Some embodiment also include capabilities related to power headroom. In particular embodiments, obtaining the indication further comprises obtaining an indication that the wireless device should use one or more bits of the random access procedure message 3 to indicate a capability of the wireless device for reporting power headroom. In particular embodiments, one or more bits of the random access procedure message 3 further indicate a power headroom measurement performed by the wireless device.

Particular bits or combinations of bits used for signaling are described in more detail with respect to the embodiments and examples described herein. In particular embodiments, the wireless device obtains the indication according to any of the embodiments and examples described herein.

At step 1314, the wireless device sets one or more bits of the random access procedure message 3 to indicate the capability of the wireless device for performing repetition when transmitting the random access procedure message 4 physical uplink control channel.

In some embodiments, the wireless device sets one or more bits of the random access procedure message 3 to indicate the capability of the wireless device for reporting power headroom.

In particular embodiments, the wireless device sets one or more bits of the random access procedure message 3 according to any of the embodiments and examples described herein.

At step 1316, the wireless device transmits the random access procedure message 3 to a network node. The wireless device may then subsequently transmit random access procedure message 4 according to the indicated capabilities in message 3, or the network node may configure the wireless device to transmit random access procedure message 4 according to a subset of the indicated capabilities in message 3 (e.g., fewer repetitions).

Modifications, additions, or omissions may be made to method 1300 of FIG. 13. Additionally, one or more steps in the method of FIG. 13 may be performed in parallel or in any suitable order.

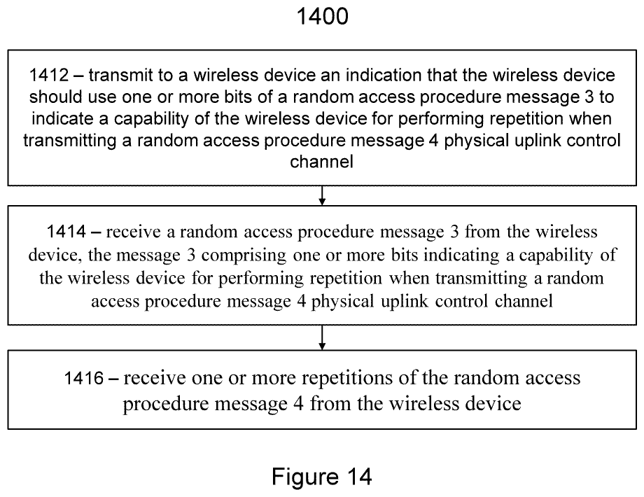

FIG. 14 is a flowchart illustrating a method 1400 performed by a network node according to certain embodiments. In particular embodiments, one or more steps of FIG. 14 may be performed by network node 162 described with respect to FIG. 4.

The method may begin at step 1412, where the network node (e.g., network node 160) transmits to the wireless device an indication that the wireless device should use one or more bits of a random access procedure message 3 to indicate a capability of the wireless device for performing repetition when transmitting a random access procedure message 4 physical uplink control channel. In particular embodiments, transmitting the indication comprises transmitting system information, transmitting a random access response, or a combination of both, as described in more detail above.

In particular embodiments, transmitting the indication further comprises transmitting an indication of a number of repetitions the wireless device is to use when transmitting a random access procedure message 4 physical uplink control channel.

In particular embodiments, the network node transmits the indication according to any of the embodiments and examples described herein.

At step 1414, the network node receives a random access procedure message 3 from a wireless device. The message 3 comprises one or more bits indicating a capability of the wireless device for performing repetition when transmitting a random access procedure message 4 physical uplink control channel.

In particular embodiments, the message 3 further comprises an indication that the wireless device is capable of using one or more bits of the random access procedure message 3 to indicate a capability of the wireless device for reporting power headroom. In particular embodiments, the one or more bits of the random access procedure message 3 further indicate a power headroom measurement performed by the wireless device.

In particular embodiments, the network receives the random access message 3 according to any of the embodiments and examples described herein.

At step 1416, the network node receives one or more repetitions of the random access procedure message 4 from the wireless device.

Modifications, additions, or omissions may be made to method 1400 of FIG. 14. Additionally, one or more steps in the method of FIG. 14 may be performed in parallel or in any suitable order.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

Some example embodiments are shown below.

### EXAMPLE EMBODIMENTS

### Group A Embodiments

1. A method performed by a wireless device, the method comprising:
   a. obtaining an indication that the wireless device should use one or more bits of a random access procedure message 3 to indicate a capability of the wireless device for performing repetition when transmitting a random access procedure message 4 physical uplink control channel;
   b. setting one or more bits of the random access procedure message 3 to indicate the capability of the wireless device for performing repetition when transmitting the random access procedure message 4 physical uplink control channel; and
   c. transmitting the random access procedure message 3 to a network node.
2. The method of embodiment 1, wherein obtaining the indication comprises obtaining system information.
3. The method of embodiment 1, wherein obtaining the indication comprises obtaining a random access response.
4. The method of any one of embodiments 1-3, further comprising receiving an indication of a number of repetitions the wireless device is to use when transmitting a random access procedure message 4 physical uplink control channel.
5. A method performed by a wireless device, the method comprising:
   a. obtaining an indication that the wireless device should use one or more bits of a random access procedure message 3 to indicate a capability of the wireless device for reporting power headroom;
   b. setting one or more bits of the random access procedure message 3 to indicate the capability of the wireless device for reporting power headroom; and
   c. transmitting the random access procedure message 3 to a network node.
6. The method of embodiment 5, wherein obtaining the indication comprises obtaining system information.
7. The method of embodiment 5, wherein obtaining the indication comprises obtaining a random access response.
8. The method of embodiment 5, wherein the one or more bits of the random access procedure message 3 further indicate a power headroom measurement performed by the wireless device.
9. A method performed by a wireless device, the method comprising:
   a. any of the wireless device steps, features, or functions described above, either alone or in combination with other steps, features, or functions described above.
10. The method of the previous embodiments, further comprising one or more additional wireless device steps, features or functions described above.
11. The method of any of the previous embodiments, further comprising:
   providing user data; and
   forwarding the user data to a host computer via the transmission to the base station.

### Group B Embodiments

12. A method performed by a base station, the method comprising:
   a. receiving a random access procedure message 3 comprising one or more bits indicating a capability of the wireless device for performing repetition when transmitting a random access procedure message 4 physical uplink control channel; and
   b. receiving one or more repetitions of the random access procedure message 4 from the wireless device.
13. The method of the previous embodiments, wherein the random access procedure message 3 further comprises one or more bits indicating a capability of the wireless device for reporting power headroom.
14. A method performed by a base station, the method comprising:
   a. any of the base station steps, features, or functions described above, either alone or in combination with other steps, features, or functions described above.
15. A method performed by a base station, the method comprising:
   a. any of the base station steps, features, or functions described above, either alone or in combination with other steps, features, or functions described above.
16. The method of the previous embodiments, further comprising one or more additional base station steps, features or functions described above.
17. The method of any of the previous embodiments, further comprising:
   obtaining user data; and
   forwarding the user data to a host computer or a wireless device.

### Group C Embodiments

18. A wireless device comprising:
   processing circuitry configured to perform any of the steps of any of the Group A embodiments; and
   power supply circuitry configured to supply power to the wireless device.
19. A base station comprising:
   processing circuitry configured to perform any of the steps of any of the Group B embodiments;
   power supply circuitry configured to supply power to the wireless device.
20. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
21. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
22. The communication system of the pervious embodiment further including the base station.
23. The communication system of the previous 2 embodiments, further including the UE, wherein the UE is configured to communicate with the base station.
24. The communication system of the previous 3 embodiments, wherein:
   the processing circuitry of the host computer is configured to execute a host application, thereby providing the user data; and
   the UE comprises processing circuitry configured to execute a client application associated with the host application.
25. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
26. The method of the previous embodiment, further comprising, at the base station, transmitting the user data.
27. The method of the previous 2 embodiments, wherein the user data is provided at the host computer by executing a host application, the method further comprising, at the UE, executing a client application associated with the host application.
28. A user equipment (UE) configured to communicate with a base station, the UE comprising a radio interface and processing circuitry configured to performs any of the previous 3 embodiments.
29. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
30. The communication system of the previous embodiment, wherein the cellular network further includes a base station configured to communicate with the UE.
31. The communication system of the previous 2 embodiments, wherein:
   the processing circuitry of the host computer is configured to execute a host application, thereby providing the user data; and
   the UE's processing circuitry is configured to execute a client application associated with the host application.
32. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
33. The method of the previous embodiment, further comprising at the UE, receiving the user data from the base station.
34. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
35. The communication system of the previous embodiment, further including the UE.
36. The communication system of the previous 2 embodiments, further including the base station, wherein the base station comprises a radio interface configured to communicate with the UE and a communication interface configured to forward to the host computer the user data carried by a transmission from the UE to the base station.
37. The communication system of the previous 3 embodiments, wherein:
   the processing circuitry of the host computer is configured to execute a host application; and
   the UE's processing circuitry is configured to execute a client application associated with the host application, thereby providing the user data.
38. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
39. A method implemented in a communication system including a host computer, a base station and a user equipment (UE), the method comprising:
   at the host computer, receiving user data transmitted to the base station from the UE, wherein the UE performs any of the steps of any of the Group A embodiments.
40. The method of the previous embodiment, further comprising, at the UE, providing the user data to the base station.
41. The method of the previous 2 embodiments, further comprising:
   at the UE, executing a client application, thereby providing the user data to be transmitted; and
   at the host computer, executing a host application associated with the client application.
42. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
43. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
44. The communication system of the previous embodiment further including the base station.
45. The communication system of the previous 2 embodiments, further including the UE, wherein the UE is configured to communicate with the base station.
46. The communication system of the previous 3 embodiments, wherein:
   the processing circuitry of the host computer is configured to execute a host application;
   the UE is configured to execute a client application associated with the host application, thereby providing the user data to be received by the host computer.
47. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
48. The method of the previous embodiment, further comprising at the base station, receiving the user data from the UE.
49. The method of the previous 2 embodiments, further comprising at the base station, initiating a transmission of the received user data to the host computer.

1. A method performed by a wireless device, the method comprising:
obtaining an indication that the wireless device should use one or more bits of a random access procedure message 3 to indicate a capability of the wireless device for performing repetition when transmitting a random access procedure message 4 physical uplink control channel;
setting one or more bits of the random access procedure message 3 to indicate the capability of the wireless device for performing repetition when transmitting the random access procedure message 4 physical uplink control channel; and
transmitting the random access procedure message 3 to a network node.

2. The method of claim 1, wherein:
obtaining the indication further comprises obtaining an indication that the wireless device should use one or more bits of the random access procedure message 3 to indicate a capability of the wireless device for reporting power headroom; and
setting one or more bits of the random access procedure message 3 further comprises setting one or more bits of the random access procedure message 3 to indicate the capability of the wireless device for reporting power headroom.

3. The method of claim 2, wherein the one or more bits of the random access procedure message 3 further indicate a power headroom measurement performed by the wireless device.

4. The method of claim 1, wherein obtaining the indication comprises obtaining system information.

5. The method of claim 1, wherein obtaining the indication comprises obtaining a random access response.

6. The method of claim 1, wherein obtaining the indication comprises obtaining an indication that the wireless device is accessing a non-terrestrial network.

7. The method of claim 1, wherein obtaining the indication further comprises obtaining an indication of a number of repetitions the wireless device is to use when transmitting a random access procedure message 4 physical uplink control channel.

8. A wireless device comprising processing circuitry operable to:
obtain an indication that the wireless device should use one or more bits of a random access procedure message 3 to indicate a capability of the wireless device for performing repetition when transmitting a random access procedure message 4 physical uplink control channel;
set one or more bits of the random access procedure message 3 to indicate the capability of the wireless device for performing repetition when transmitting the random access procedure message 4 physical uplink control channel; and
transmit the random access procedure message 3 to a network node.

9. The wireless device of claim 8, wherein:
the processing circuitry is further operable to obtain the indication by obtaining an indication that the wireless device should use one or more bits of the random access procedure message 3 to indicate a capability of the wireless device for reporting power headroom; and
the processing circuitry is further operable to set one or more bits of the random access procedure message 3 further by setting one or more bits of the random access procedure message 3 to indicate the capability of the wireless device for reporting power headroom.

10. The wireless device of claim 9, wherein the one or more bits of the random access procedure message 3 further indicate a power headroom measurement performed by the wireless device.

11. The wireless device of claim 8, wherein the processing circuitry is operable to obtain the indication by obtaining system information.

12. The wireless device of claim 8, wherein the processing circuitry is operable to obtain the indication by obtaining a random access response.

13. The wireless device of claim 8, wherein the processing circuitry is operable to obtain the indication by obtaining an indication that the wireless device is accessing a non-terrestrial network.

14. The wireless device of claim 8, wherein the processing circuitry is further operable to obtain the indication by obtaining an indication of a number of repetitions the wireless device is to use when transmitting a random access procedure message 4 physical uplink control channel.

15. A method performed by a network node, the method comprising:
receiving a random access procedure message 3 from a wireless device, the message 3 comprising one or more bits indicating a capability of the wireless device for performing repetition when transmitting a random access procedure message 4 physical uplink control channel; and
receiving one or more repetitions of the random access procedure message 4 from the wireless device.

16. The method of claim 15, wherein the message 3 further comprises an indication that the wireless device is capable of using one or more bits of the random access procedure message 3 to indicate a capability of the wireless device for reporting power headroom.

17. The method of claim 16, wherein the one or more bits of the random access procedure message 3 further indicate a power headroom measurement performed by the wireless device.

18. The method of claim 15, further comprising transmitting to the wireless device an indication that the wireless device should use one or more bits of a random access procedure message 3 to indicate a capability of the wireless device for performing repetition when transmitting a random access procedure message 4 physical uplink control channel.

19. The method of claim 18, wherein transmitting the indication comprises transmitting system information.

20. The method of claim 18, wherein transmitting the indication comprises transmitting a random access response.

21. The method of claim 1, wherein transmitting the indication further comprises transmitting an indication of a number of repetitions the wireless device is to use when transmitting a random access procedure message 4 physical uplink control channel.

22. A network node comprising processing circuitry operable to:
receive a random access procedure message 3 from a wireless device, the message 3 comprising one or more bits indicating a capability of the wireless device for performing repetition when transmitting a random access procedure message 4 physical uplink control channel; and
receive one or more repetitions of the random access procedure message 4 from the wireless device.

23.-28. (canceled)
